(19) United States
(12) Patent Application Publication
(10) Pub. No.: US 2012/0219069 A1
(43) Pub. Date: Aug. 30, 2012

(54) METHODS AND APPARATUSES FOR ENCODING AND DECODING IMAGES OF A PLURALITY OF VIEWS USING MULTIVIEW VIDEO CODING STANDARD AND MPEG-2 VIDEO STANDARD

(76) Inventors: Chong Soon LIM, Singapore (SG); Takahiro Nishi, Nara (JP); Hisao Sasai, Osaka (JP)

(21) Appl. No.: 13/036,768

(22) Filed: Feb. 28, 2011

(51) Int. Cl. H04N 7/26; H04N 7/24

(52) U.S. Cl. 375/240.25; 375/240.26; 375/E07.022; 375/E07.2

(57) ABSTRACT

The MPEG-4 Multiview Video Coding (MVC) standard provides the coding tools to compress images from more than one view. Traditionally, the base view of the multiple view images has to be coded by the MPEG-4 Advance Video Coding (AVC) standard. However, in some deployments, for compatibility to legacy players, MPEG-2 Video standard has to be used for the coding of the based view. This invention provides methods and apparatuses to compute the parameters required by the MVC encoder and decoder without signalling such information in the base view that is coded by the MPEG-2 video standard.

### BACKGROUND OF THE INVENTION

1. Technical Field

This invention can be used in any multimedia data coding and, more particularly, in Multiview Video Coding.

2. Description of Related Art

MPEG-4 Multiview Video Coding (MVC) standard is created as an extension of ISO/IEC 14496-10 Advanced Video Coding (AVC) standard. The profiles created in the MVC standard are designed to be backward compatible to some of the profiles defined in AVC standard. In another words, the decoders or players conforming to the new MVC profiles will be able to decode some of the AVC profile bitstreams. Vice versa, legacy decoders of the AVC profiles (in particularly the High profile) should also decode at least one of the views in bitstreams conforming to the new MVC profiles.

In MPEG-4 Multiview Video Coding (MPEG-4 MVC) standard, as a coded base view is required to be compatible to the profiles defined by AVC standard, a legacy decoder conforming to the High Profile of the AVC standard should be able to decode a base view in the MVC bitstream conforming to the MVC profiles. The coded views are contained in Network Abstraction Layer (NAL) units and different types of NAL unit are differentiated by NAL unit type values. The non-base views are contained in NAL unit with unit type values that are reserved values in the previous versions of the AVC specification and thus these NAL units should be ignored by legacy High profile decoders.

In the MPEG-4 MVC standard, a particular NAL unit called Prefix NAL unit is required to be sent together before each NAL unit containing the coded base view. This Prefix NAL unit has a NAL unit type value equal to fourteen and it is a reserved value in the previous versions of the AVC specification.

The Prefix NAL unit contains additional parameters that are located in the MVC extension of the NAL unit header. These parameters are associated with the base view and are used in the encoding and decoding processes of the compressed non base views. FIG. 1 shows a diagram on the location of NAL unit header mvc extension syntaxes. The parameters in the NAL unit header mvc extension include a non_idr_flag parameter, a prority_id parameter, a view_id parameter, a temporal_id parameter, a anchor_pic_flag parameter, a inter_view_flag parameter and a reserved_one_bit parameter. The reserved_one_bit has a value of one and it is not used for the encoding and decoding processes of the compressed non base views.

In the MPEG-2 system standard (ISO/IEC 13818-1), the presentation time and decoding time of a B picture that is coded by MPEG-2 video standard is forced to be the same. In the case of the presence of a non base view picture that is coded by the MPEG-4 MVC standard, the presentation and decoding time of that non base view picture is also set to be the same as the base view B picture so that synchronization of the views can be achieved.

### Problems to be Solved

By the definition of the MVC standard, the base view has to be coded using the AVC standard. However, in some deployment, for compatibility to legacy players, the base view needs to be coded using an older standard like MPEG-2 Video standard.

Typically, the motion prediction process of the non base view requires the decoded images of the base view. However the additional parameters introduced by the MVC extension of the NAL unit header cannot be carried in the coded video compressed using the MPEG-2 video standard. These parameters are required for the decoding of the coded images of the non-base view that is compressed by the MVC standard.

The decoding and presentation times of the base view B picture that is coded using the MPEG-2 video is restricted to be the same as the decoding and presentation times of the non base view picture that is coded using the MPEG-4 MVC standard. But because the decoding of the non base view picture may use the decoded image of the base view B picture for inter picture prediction; the actual decoding time of the non-base view picture cannot be the same as the decoding time of the base view picture. And thus the actual presentation time of the non base view picture will be later than the presentation time of the base view picture which will create some synchronization problems for the base and non base views

### BRIEF SUMMARY OF THE INVENTION

### 1. Means of Solving the Problems

To solve the above problems, new methods are introduced to compute the parameters contained in the MVC extension of the NAL unit header for the base view image that is coded using the MPEG-2 Video standard. New methods are introduced to compute the new decoding and presentation times of the base and non base views images when the base view image is coded using the MPEG-2 video standard.

What is novel about this invention is that this invention allows the values associated to the base view of the MPEG-2 coded stream that is required for the decoding of the non base view to be determined signalling new data units that may create problems in the decoding process by some legacy MPEG-2 decoders. This invention enables the decoding of a base view of a MPEG-2 video stream by legacy MPEG-2 video decoders in the market and also enables the decoding of all the coded views of the MVC stream by MVC decoders of current invention. This invention also solves the synchronization problems of the decoded base view image and the decoded non base view image by computing new decoding and presentation times from the base and non base views images.

### 2. Effects of Invention

The effect of the current invention is in the form of backward compatibility of a coded MVC and MPEG-2 video stream on legacy players.

### BRIEF DESCRIPTION OF THE DRAWINGS

FIG. 1 is a diagram showing location of NAL unit header mvc extension parameters and picture_coding_type parameter.

FIG. 2 is a flowchart showing an encoding process for the first embodiment of current invention.

FIG. 3 is a flowchart showing a decoding process for the first embodiment of current invention.

FIG. 4 is a flowchart showing a process to compute NAL unit header mvc extension parameters in the first embodiment of current invention.

FIG. 5 is a flowchart showing a process to assign the values for a plurality of parameters from NAL unit header mvc extension parameters of a coded image of a non base view to parameters of an image of a base view.

FIG. 6 is a diagram showing an example apparatus of an encoder in the first embodiment of current invention.

FIG. 7 is a diagram showing an example apparatus of a decoder in the first embodiment of current invention.

FIG. 8 is a diagram illustrating the location of presentation time stamp and decoding time stamp in second embodiment of current invention.

FIG. 9 is a diagram illustrating the decode and display timings of a pair of stereo images and audio data in the second embodiment of current invention.

FIG. 10 is a flowchart showing a decoding process for an image of a base view in the second embodiment of current invention.

FIG. 11 is a flowchart showing a decoding process for an image of a non base view in the second embodiment of current invention.

FIG. 12 is a flowchart showing a decoding process for audio data in the second embodiment of current invention.

FIG. 13 is a diagram showing an example apparatus of a decoder in the second embodiment of current invention.

FIG. 100 illustrates an overall configuration of a content providing system ex 100 for implementing content distribution services.

FIG. 101 illustrates a video coding apparatus and a video decoding apparatus implemented in a digital broadcasting system ex200.

FIG. 102 illustrates a television (receiver) ex300 that uses the video coding method and the video decoding method described in each of the embodiments.

FIG. 103 illustrates shows an example of a configuration of an information reproducing/recording unit ex400 when data is read or written from or on an optical disk.

FIG. 104 illustrates the recording medium ex215 that is the optical disk.

FIG. 105 (a) illustrates a cellular phone ex114 that uses the video coding method and the video decoding method described in the embodiments.

FIG. 105 (b) shows an example of a configuration of the cellular phone ex114.

FIG. 106 illustrates a structure of multiplexed data that can be obtained by multiplexing at least one of a video stream, an audio stream, a presentation graphics stream (PG), and an interactive graphics stream.

FIG. 107 schematically illustrates how data is multiplexed.

FIG. 108 illustrates how a video stream is stored in a stream of PES packets.

FIG. 109 illustrates a format of TS packets to be finally written on the multiplexed data.

FIG. 110 illustrates the data structure of the PMT in detail.

FIG. 111 shows that each of the multiplexed data information files is management information of the multiplexed data, and that the multiplexed data includes a system rate, a reproduction start time, and a reproduction end time.

FIG. 112 shows a piece of attribute information registered in the stream attribute information, for each PID of each stream included in the multiplexed data.

FIG. 113 illustrates steps of the video decoding method according to embodiment 9.

FIG. 114 shows a CPU ex502 and a driving frequency control unit ex512 of the driving frequency switching unit ex803.

FIG. 115 illustrates a configuration ex800 in embodiment 11.

FIG. 116 illustrates steps for executing a method in Embodiment 11.

FIG. 117 shows a look-up table in which the standards of the video data are associated with the driving frequencies.

FIG. 118(a) show an example Ex900 of a configuration in which the decoding processing unit for implementing the video decoding method described in each of embodiments and the decoding processing unit that conforms to the conventional standard, such as MPEG-2, MPEG4-AVC, and VC-1 are partly shared.

FIG. 118(b) shows another example ex1000 in which processing is partly shared.

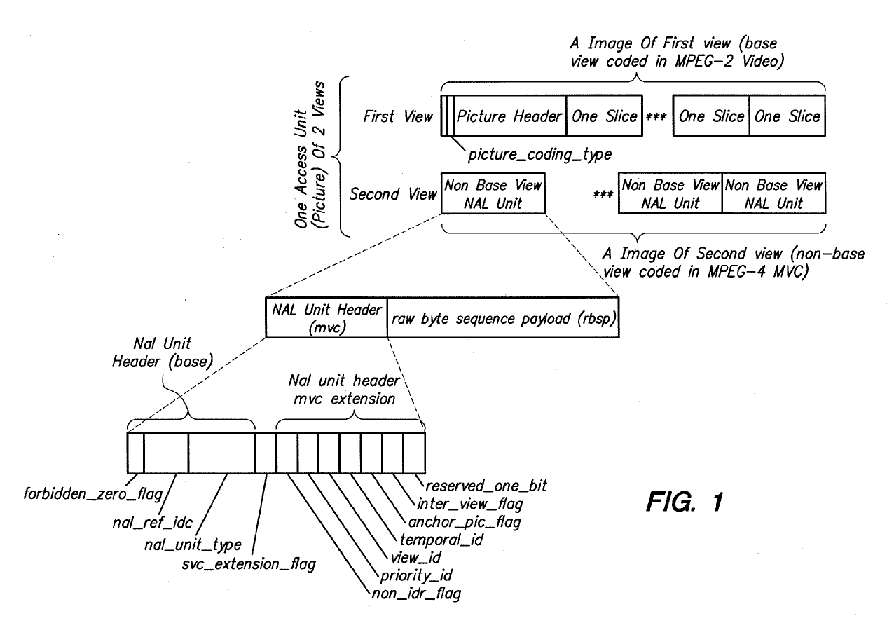

### DETAILED DESCRIPTION OF THE INVENTION

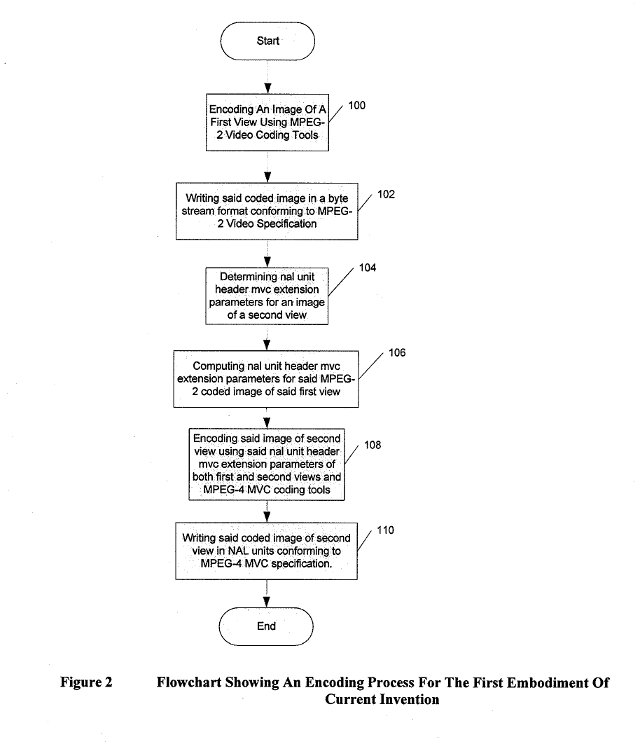

FIG. 2 shows an encoding process for the first embodiment of current invention. In module 100, an image of first view is encoded using MPEG-2 video coding tools. The first view is also known as the base view in the current invention. Next in module 102, the coded image is written in a byte stream format conforming to the MPEG-2 video specification. In module 104, the Network Abstraction Layer (NAL) unit header mvc extension parameters are determined for an image of the second view. The second view is also known as the non base view in the current invention. These parameters include a non_idr_flag parameter, a rority_id parameter, a view_id parameter, a temporal_id parameter, a anchor_pic_flag parameter and a inter_view_flag parameter.

As shown in FIG. 2, in module 106, the NAL unit header mvc extension parameters for the first view are computed. These parameters include a non_idr_flag parameter, a prority_id parameter, a view_id parameter, a temporal_id parameter, a anchor_pic_flag parameter and a inter_view_flag parameter. In module 108, an image of second view is encoded using the NAL unit header mvc extension parameters of both first and second views and MPEG-4 MVC coding tools. Finally in module 110, the coded image of the second view is written in NAL units conforming to the MPEG-4 MVC specification.

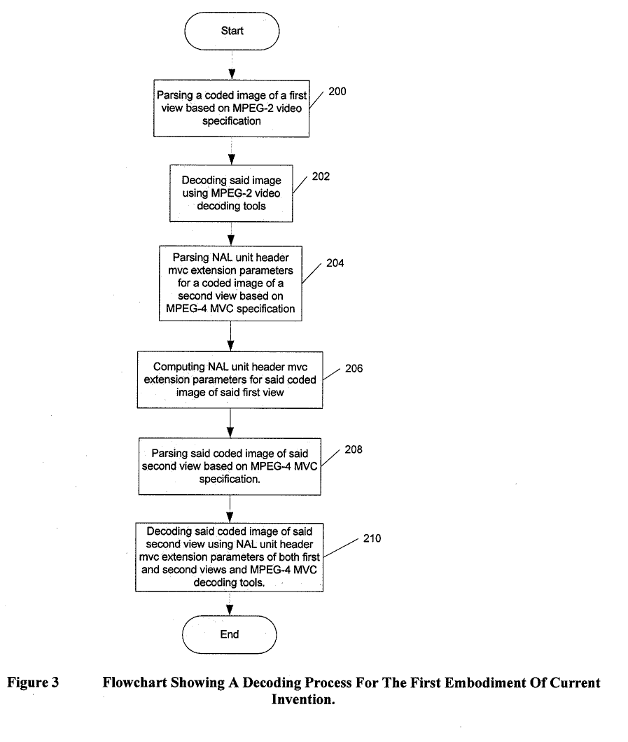

FIG. 3 shows a decoding process for the first embodiment of current invention. Firstly in module 200, a coded image of a first view is parsed based on MPEG-2 Video specification. The first view is also known as the base view in current invention. Next in module 202, the image is decoded using MPEG-2 video decoding tools. And in module 204, the NAL unit header mvc extension parameters for a coded image of a second view is parsed based on MPEG-4 MVC specification. The second view is also known as the non base view in current invention. Next in module 206, the NAL unit header mvc extension parameters for the coded image of the first view is computed and in module 208, the coded image of second view is parsed based on the MPEG-4 MVC specification. Finally, in module 210, the coded image of the second view is decoded using the NAL unit header mvc extension parameters for both first and second view and MPEG-4 MVC decoding tools.

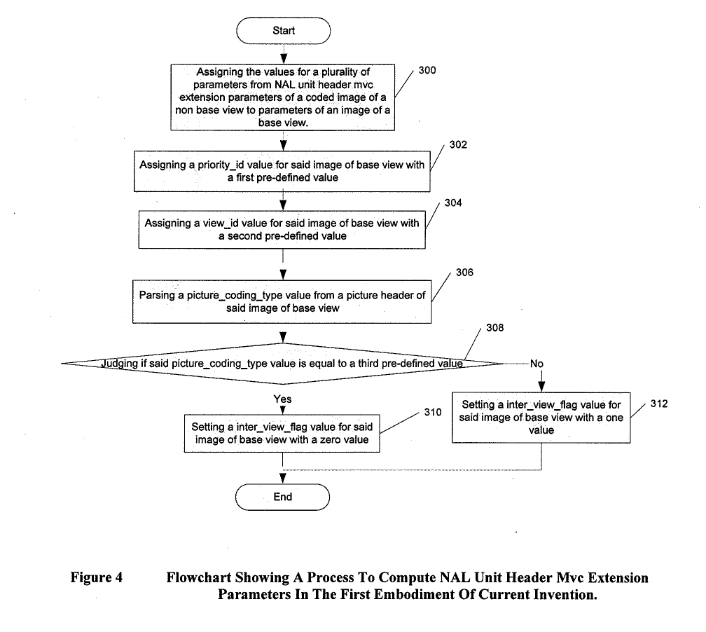

FIG. 4 shows a process to compute NAL unit header mvc extension parameters in the first embodiment of current invention. These parameters include a non_idr_flag parameter, a prority_id parameter, a view_id parameter, a temporal_id parameter, a anchor_pic_flag parameter and a inter_view_flag parameter.

Firstly in module 300, the values for a plurality of parameters from NAL unit header mvc extension parameters of a coded image of a non base view (second view) is assigned to the parameters for a coded image of a base view (first view). Next in module 302, the priority_id value for the coded image of base view is assigned with a first pre-defined value. The pre-defined value for priority_id is zero. The view_id is also assigned with a second pre-defined value in module 304. The pre-defined value for view_id is zero. Next in module 306, a picture_coding_type parameter is parsed from a picture header of the coded image of base view. The picture_coding_type parameter identifies if the coded picture is a I picture, P picture or B picture. And in module 308, the picture_coding_type parameter is judged whether it contains a third pre-defined value. The third pre-defined value is the value three which represents a B picture. And if the picture_coding_type parameter contains the third pre-defined value, a inter_view_flag parameter for the coded image of base view is set to a value of zero in module 310. Otherwise, if the picture_coding_type parameter does not contain the third pre-defined value, the inter_view_flag parameter for the coded image of base view is set to a value of one in module 312.

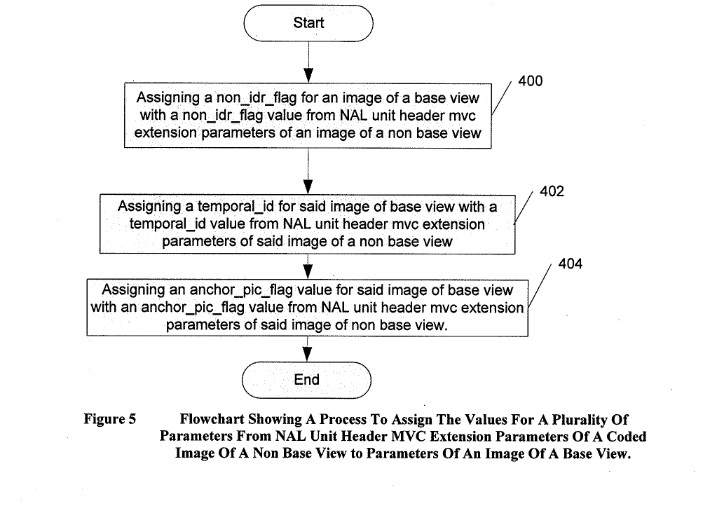

FIG. 5 shows a process to assign the values for a plurality of parameters from NAL unit header mvc extension parameters of a coded image of a non base view (second view) to the parameters for a coded image of a base view (first view). In module 400, the non_idr_flag parameter for an image of a base view is assigned with the value of the non_idr_flag parameter for an image of a non base view. Similarly, in module 402, the temporal_id parameter for the image of a base view is assigned with the value of the temporal_id parameter for the image of a non base view. And finally, in module 404, the anchor_pic_flag parameter for the image of a base view is assigned with the value of the anchor_pic_flag parameter for the image of a non base view.

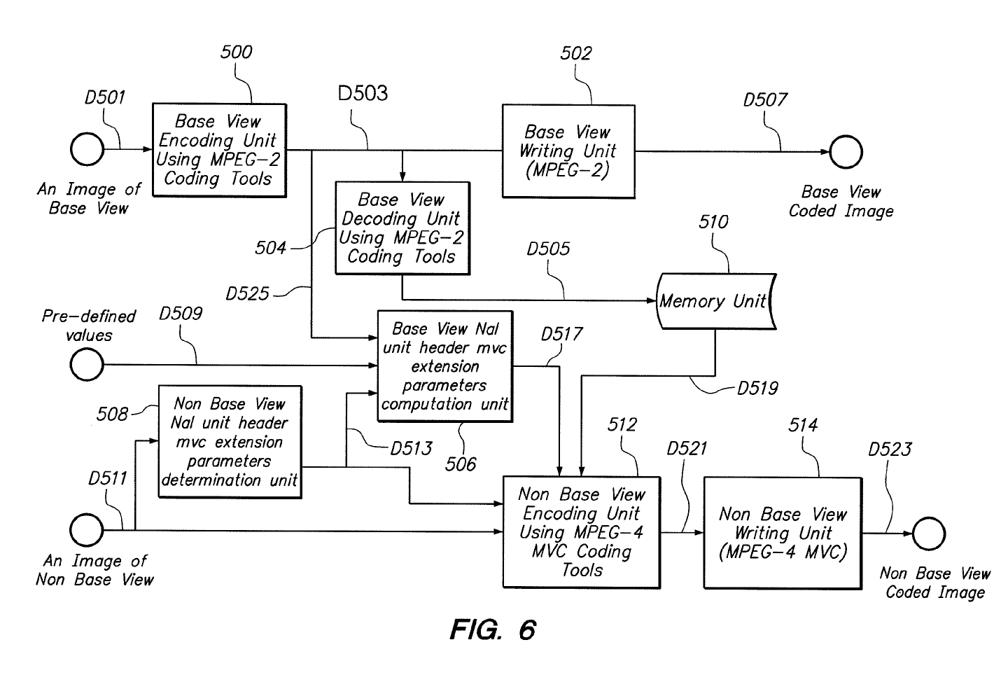

FIG. 6 shows a block diagram on an example encoder apparatus in the first embodiment of the current invention. It includes a base view encoding unit using MPEG-2 coding tools 500, a base view writing unit 502, a base view decoding unit using MPEG-2 decoding tools 504, a base view NAL unit header mvc extension parameters computation unit 506, a non base view NAL unit header mvc extension parameters determination unit 508, a memory unit 510, a non base view encoding unit using MPEG-4 MVC coding tools 512 and a non base view writing unit 514.

Firstly, an image of base view D501 is inputted to the base view encoding unit 500 and a compressed image D503 is outputted to both base view writing unit 502 and base view decoding unit 504. The pcture_coding_type parameter D525 is also outputted form the base view encoding unit 500 to the base view NAL unit header mvc extension parameters computation unit 506.

The base view decoding unit 504 reads the compressed image of base view D003, decode the image using MPEG-2 video decoding tools and outputs the decoded image of base view D005 to the memory unit 510.

As shown in FIG. 6, an image of non base view D511 is inputted to both non base view NAL unit mvc extension parameters determination unit 508 and the non base view encoding unit 512. The non base view NAL unit mvc extension parameters determination unit 508 then outputs the NAL unit header mvc extension parameters of the non base view D513 to both base view NAL unit header mvc extension parameters computation unit 506 and the non base view encoding unit 512. The base view Nal unit header mvc extension parameters computation unit 506 takes the pre-defined values, the picture_coding_type parameter D525 and the NAL unit header mvc extension parameters of the non base view D513, assign values to the NAL unit header mvc extension parameters of base view and outputs the NAL unit header mvc extension parameters of base view D517 to the non base view encoding unit 512.

The non base view encoding unit 512 then takes an image of non base view D511, the NAL unit header mvc extension parameters of the non base view D513, the NAL unit header mvc extension parameters of the base view D517 and a decoded image of base view D519, encodes the image using MPEG-4 MVC coding tools and outputs a compressed image of non base view D521.

Finally, the base view writing unit 502 and the non base view writing unit 514, takes the compressed image of base view D503 and the compressed image of non base view D521, respectively and outputs the compressed images D507 and D523.

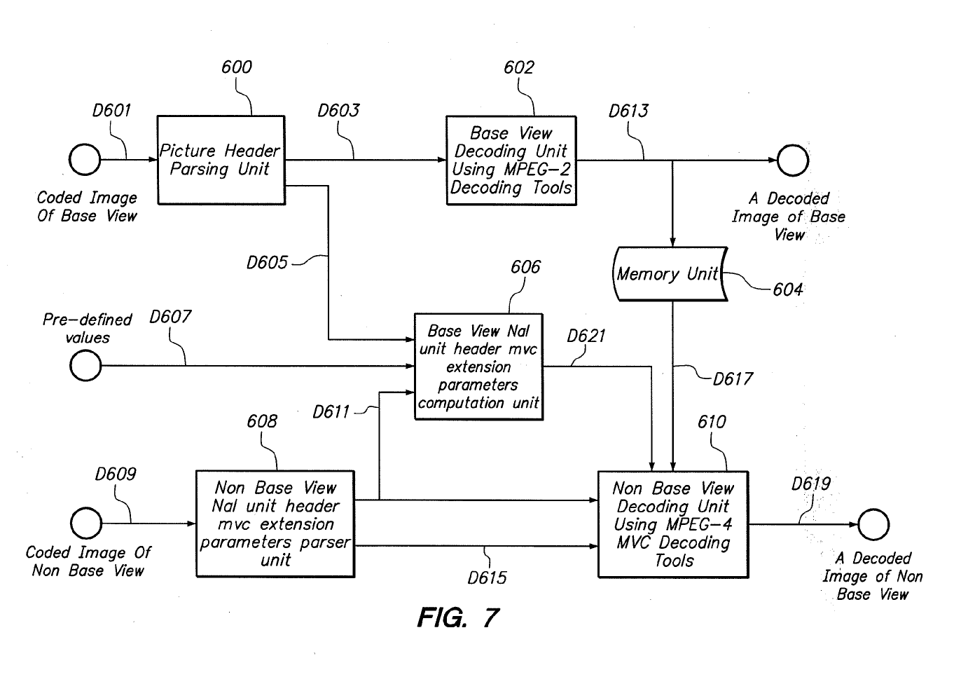

FIG. 7 shows a block diagram on an example decoder apparatus in the first embodiment of the current invention. It includes a picture header parsing unit 600, a base view decoding unit using MPEG-2 decoding tools 602, a memory unit 604, a non base view NAL unit header mvc extension parameters parser unit 608, a base view Nal unit header mvc extension parameters computation unit 606 and a non base view decoding unit using MPEG-4 MVC decoding tools 610.

As shown in FIG. 7, the picture header parsing unit 600 reads a coded image of base view and outputs a compressed image to the base view decoding unit 602. The base view decoding unit takes the compressed base view image D603, decodes using MPEG-2 decoding tools and outputs a decoded image of base view D613. The outputted decoded image of base view D613 is then stored in the memory unit 604.

The picture header parsing unit 600 also outputs a picture_coding_type parameter to the base view NAL unit header mvc extension parameters computation unit 606.

The non base view NAL unit header mvc extension parameters parser unit 608, takes the compressed image of non base view D609 and outputs the NAL unit header mvc extension parameters of non base view D611 to both base view NAL unit header mvc extension parameters computation unit 606 and non base view decoding unit 610. The non base view NAL unit header mvc extension parameters parser unit 608 also outputs the compressed image of non base view D615 to the non base view decoding unit 610. Then the base view NAL unit header mvc extension parameters computation unit 606 takes the pre-defined values D607, the picture_coding_type parameter D605 and the NAL unit header mvc extension parameters of non base view D611, assigns values to the NAL unit header mvc extension parameters of base view and outputs the NAL unit header mvc extension parameters of base view D621 to the non base view decoding unit 610.

Finally the non base view decoding unit 610 takes the decoded image of base view D617, NAL unit header mvc extension parameters of base view D621, parsed NAL unit header mvc extension parameters of non base view D611 and a compressed image of non base view D615, decodes using MPEG-4 MVC decoding tools and outputs the decoded image of non base view D019.

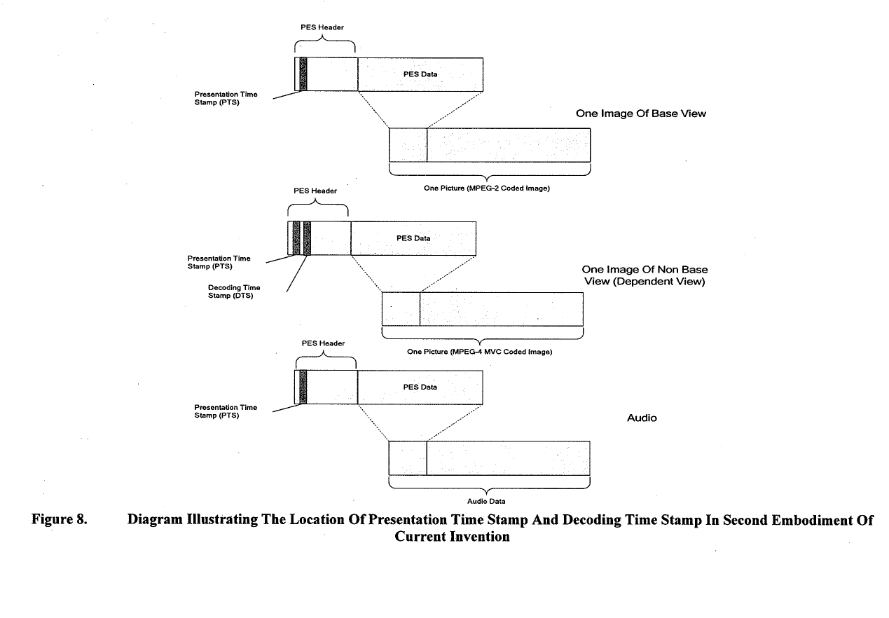

FIG. 8 shows a diagram illustrating the location of the presentation time stamp (PTS) and decoding time stamp (DTS) in the second embodiment of the current invention. As shown in the diagram, the PTS can be found in the PES header that encapsulates the media data containing either an image of base view, an image of non base view or audio samples. As shown in the diagram, in the case when PES data contains an image of the base view that is a B picture and in the case the PES data contains audio samples, the DTS is the same as the PTS and the DTS may not be present in the PES header of a PES packet.

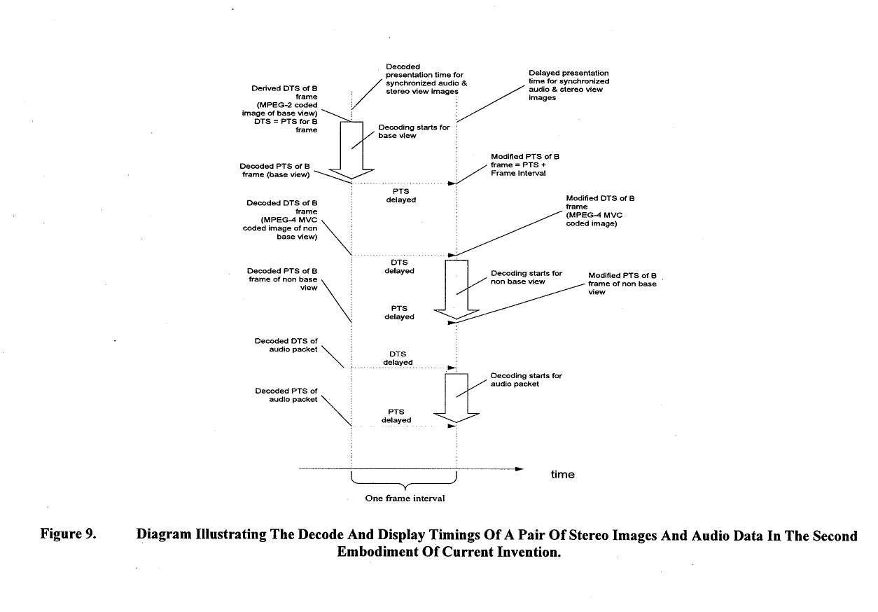

FIG. 9 shows a diagram illustrating the decoding and display timings of a pair of stereo images and the associated audio samples in the second embodiment of the current invention. As shown in the diagram, the presentation time for the image of the base view and the decoding and presentation times of the image of the non base view and associated audio samples are all delayed by one frame interval to ensure that the decoded media as synchronized in playback. The frame interval is computed as the time duration equal to the inverse of the frame rate.

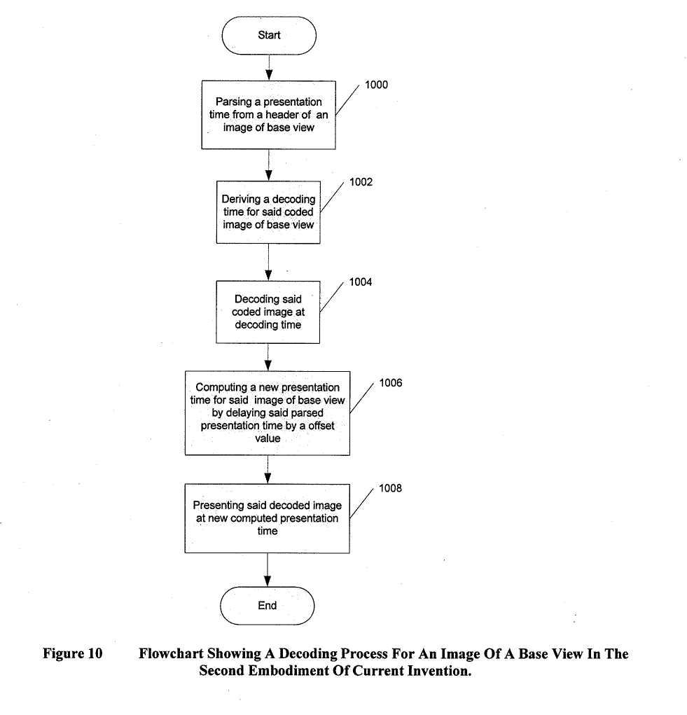

FIG. 10 shows a decoding process for an image of a base view in the second embodiment of the current invention. Firstly in module 1000, a presentation time is parsed from a header of an image of base view. Specifically, the parameter is parsed from a PES packet header containing a part of the image. Next in module 1002, a decoding time is derived for the coded image of the base view. If the coded image is a B picture, the decoded time is derived to be the same value as the presentation time. And in module 1004, the image is decoded at the derived decoding time and a new presentation time for the decoded image is computed by delaying the parsed presentation time by an offset value in module 1006. The offset value is the time duration that is the inverse of the frame rate. And finally in module 1008, the decoded image of the base view is presented at the new computed presentation time.

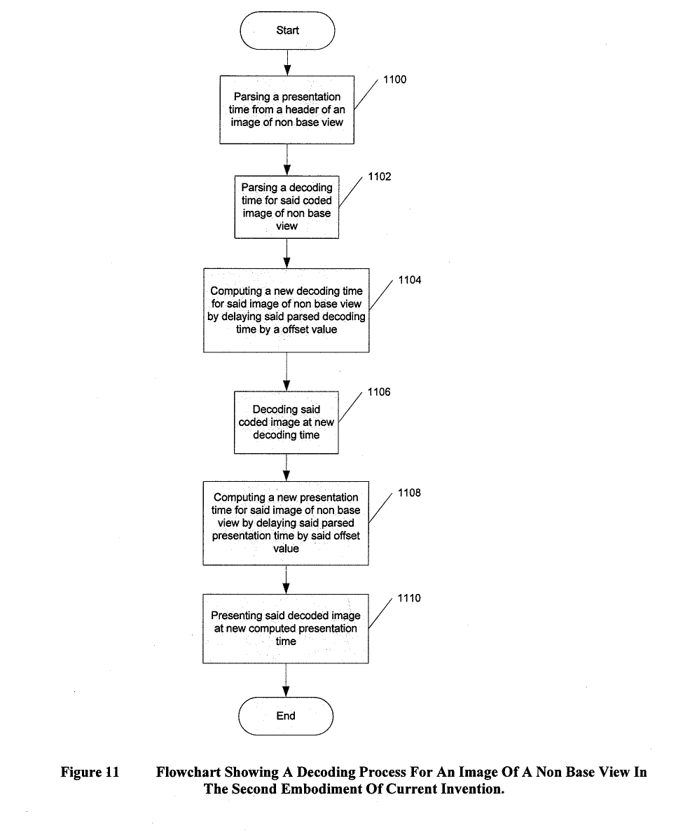

FIG. 11 shows a decoding process for an image of a non base view in the second embodiment of the current invention. Firstly in module 1100, a presentation time is parsed from a header of an image of non base view. Specifically, the parameter is parsed from a PES packet header containing a part of the image. Next in module 1102, a decoding time is parsed from the header. And in module 1104, a new decoding time for the image of the non base view is computed by delaying the decoding time by an offset value. The offset value is the time duration that is the inverse of the frame rate. And in module 1106, the image is decoded at the newly computed decoding time and a new presentation time for the decoded image is computed by delaying the parsed presentation time by the same offset value in module 1108. And finally in module 1110, the decoded image of the non base view is presented at the new computed presentation time.

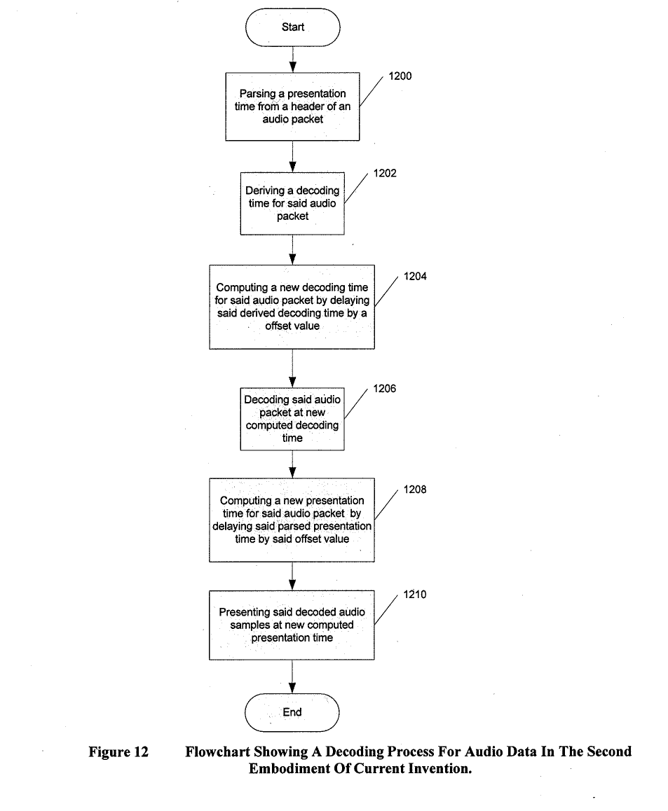

FIG. 12 shows a decoding process for audio samples in the second embodiment of the current invention. Firstly in module 1200, a presentation time is parsed from a header of the audio samples. Specifically, the parameter is parsed from a PES packet header containing a part of audio samples. Next in module 1202, a decoding time is parsed from the header. And in module 1204, a new decoding time for audio samples is computed by delaying the decoding time by an offset value. The offset value is the time duration that is the inverse of the video frame rate. And in module 1206, the audio samples are decoded at the newly computed decoding time and a new presentation time for the decoded audio samples is computed by delaying the parsed presentation time by the same offset value in module 1208. And finally in module 1210, the decoded audio samples are presented at the new computed presentation time.

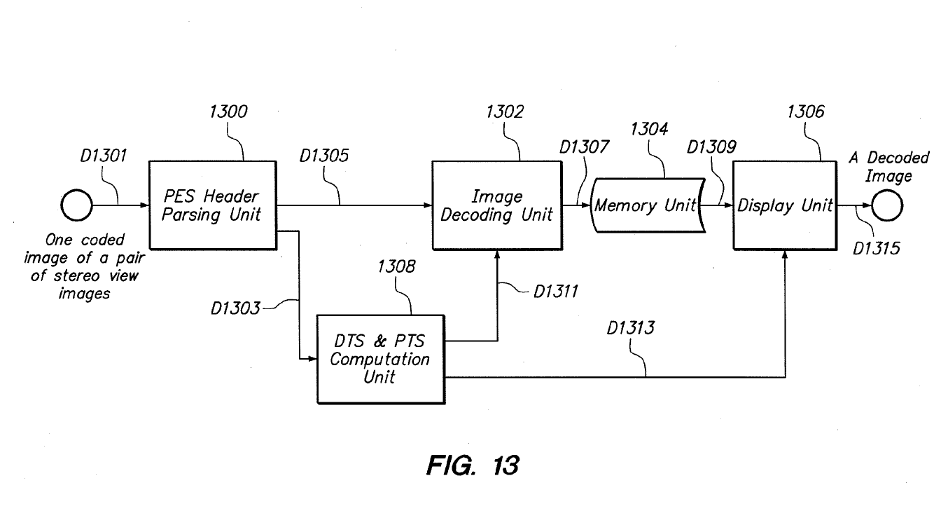

FIG. 13 shows an example apparatus of a decoder in the second embodiment of the current invention. It consists of a PES header parsing unit 1300, an image decoding unit 1302, a memory unit 1304, a display unit 1306 and a DTS and PTS computation unit 1308.

Firstly the PES header parsing unit 1300 reads a coded image which is encapsulated in PES packets D1301 and outputs the presentation time stamp (PTS) and if present, the decoding time stamp (DTS) D1303 to the DTS and PTS computation unit 1308. The PES header parsing unit 1300 also outputs the coded image D1305 to the image decoding unit 1302. The DTS and PTS computation unit reads the parsed presentation time stamp (PTS) and the decoding time stamp (DTS) D1303 and outputs new computed decoding time D1311 to the image decoding unit 1302 and new computed presentation time D1313 to the display unit 1306. The image decoding unit 1302 reads the decoding time D1311 and the coded image D1305 and outputs the decoded image D1307 to the memory unit 1304. The display unit D1315 then reads the presentation time D1313 and the decoded image D1309 from the memory unit 1304 and outputs the image for display D1315.

### Embodiment A

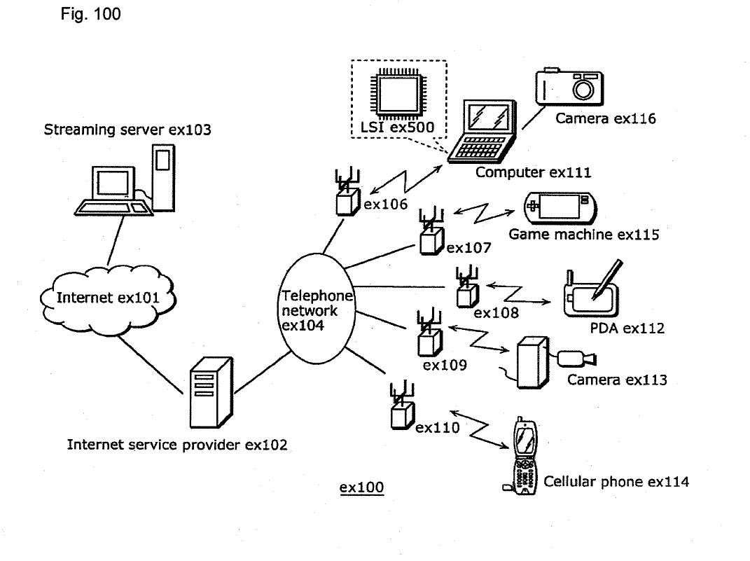

The processing described in each of the Embodiments shown in FIGS. 100 to 118(b) can be simply implemented in an independent computer system, by recording, in a recording medium, a program for implementing the configurations of the video coding method and the video decoding method described in each of Embodiments. The recording media may be any recording media as long as the program can be recorded, such as a magnetic disk, an optical disk, a magnetic optical disk, an IC card, and a semiconductor memory.

Hereinafter, the applications to the video coding method and the video decoding method described in each of Embodiments and systems using thereof will be described.

FIG. 100 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex 104, as well as the base stations ex 106 to ex 110, respectively.

However, the configuration of the content providing system ex100 is not limited to the configuration shown in FIG. 100, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera exi 13, such as a digital video camera, is capable of capturing video. A camera exi 16, such as a digital video camera, is capable of capturing both still images and video. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of Embodiments, and the coded content is transmitted to the streaming server ex103. On the other hand, the streaming server ex103 carries out stream distribution of the transmitted content data to the clients upon their requests. The clients include the computer ex 111, the PDA ex 112, the camera ex 113, the cellular phone ex 114, and the game machine ex115 that are capable of decoding the above-mentioned coded data. Each of the devices that have received the distributed data decodes and reproduces the coded data.

The captured data may be coded by the camera ex113 or the streaming server ex103 that transmits the data, or the coding processes may be shared between the camera ex 113 and the streaming server ex103. Similarly, the distributed data may be decoded by the clients or the streaming server ex103, or the decoding processes may be shared between the clients and the streaming server ex 103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

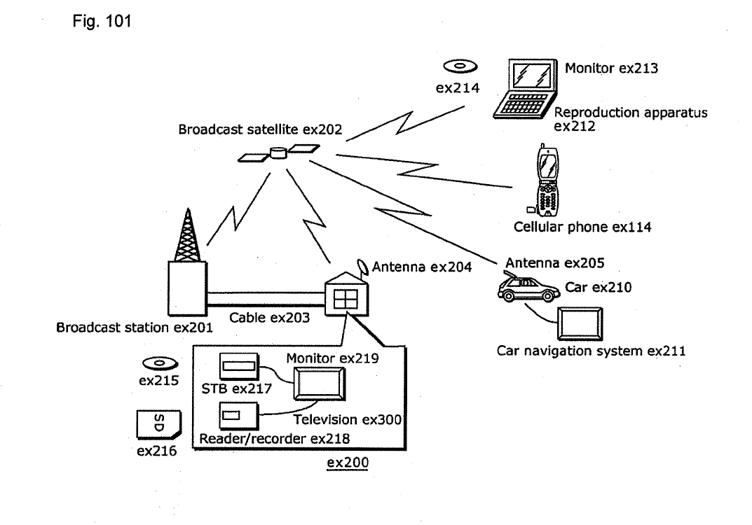

Aside from the example of the content providing system ex 100, at least one of the video coding apparatus and the video decoding apparatus described in each of Embodiments may be implemented in a digital broadcasting system ex200 illustrated in FIG. 101. More specifically, a broadcast station ex201 communicates or transmits, via radio waves to a broadcast satellite ex202, multiplexed data obtained by multiplexing audio data and others onto video data. The video data is data coded by the video coding method described in each of Embodiments. Upon receipt of the multiplexed data, the broadcast satellite ex202 transmits radio waves for broadcasting. Then, a home-use antenna ex204 with a satellite broadcast reception function receives the radio waves.

Next, a device such as a television (receiver) ex300 and a set top box (STB) ex217 decodes the received multiplexed data, and reproduces the decoded data.

Furthermore, a reader/recorder ex218 (i) reads and decodes the multiplexed data recorded on a recording media ex215, such as a DVD and a BD, or (i) codes video signals in the recording medium ex215, and in some cases, writes data obtained by multiplexing an audio signal on the coded data. The reader/recorder ex218 can include the video decoding apparatus or the video coding apparatus as shown in each of Embodiments. In this case, the reproduced video signals are displayed on the monitor ex219, and can be reproduced by another device or system using the recording medium ex215 on which the multiplexed data is recorded. It is also possible to implement the video decoding apparatus in the set top box ex217 connected to the cable ex203 for a cable television or to the antenna ex204 for satellite and/or terrestrial broadcasting, so as to display the video signals on the monitor ex219 of the television ex300. The video decoding apparatus may be implemented not in the set top box but in the television ex300.

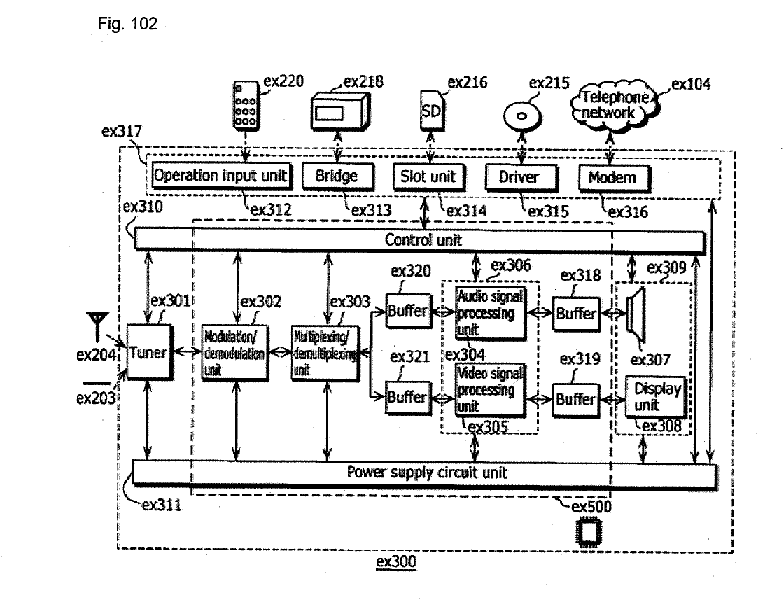

FIG. 102 illustrates the television (receiver) ex300 that uses the video coding method and the video decoding method described in each of Embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively; and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of Embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of Embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

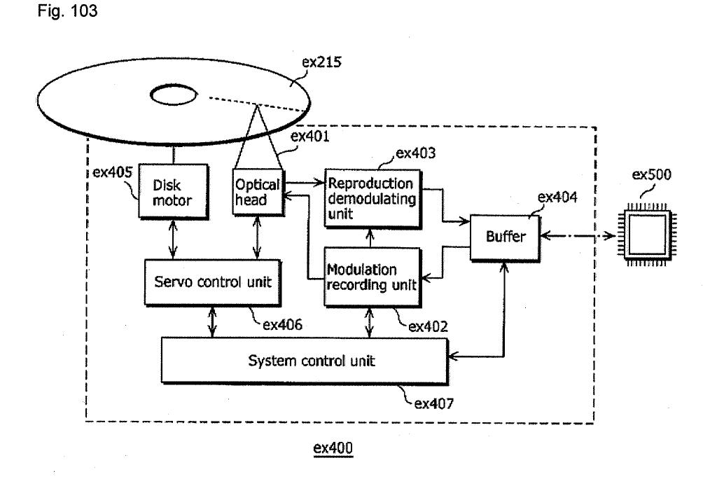

As an example, FIG. 103 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

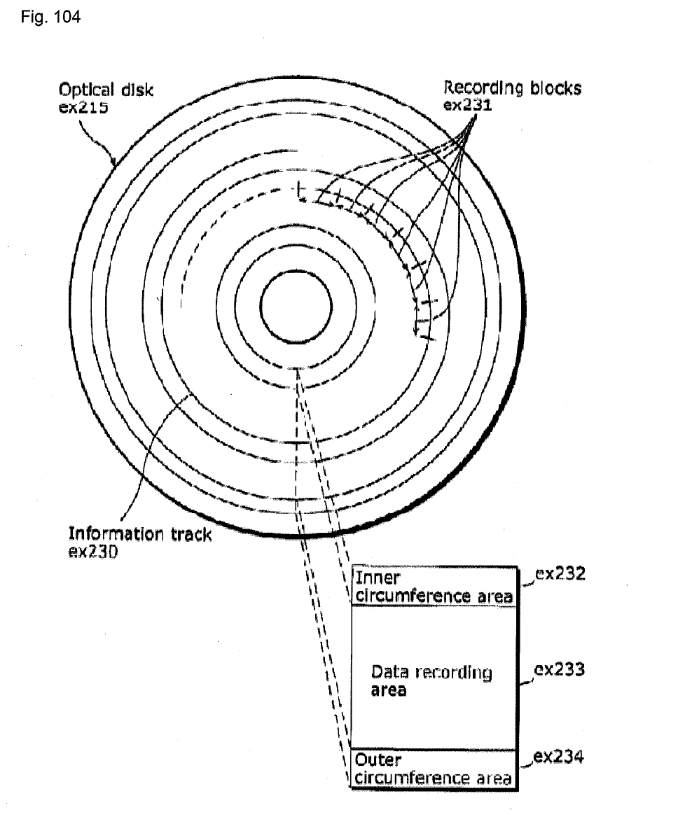

FIG. 104 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 102. The same will be true for the configuration of the computer ex 111, the cellular phone ex 114, and others.

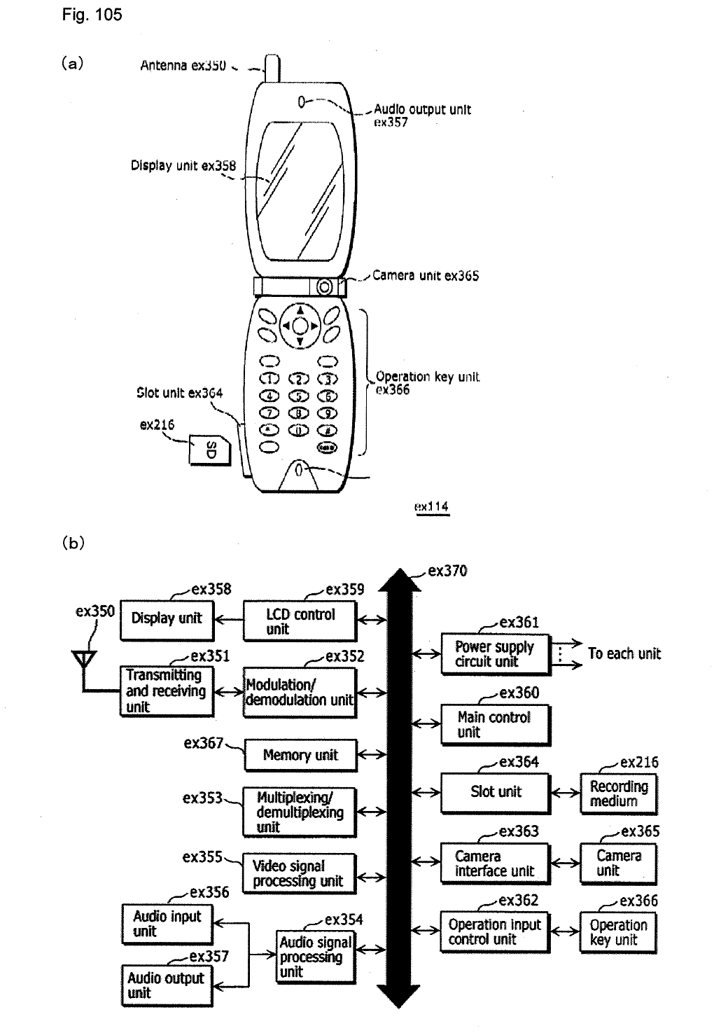

FIG. 105 (a) illustrates the cellular phone ex114 that uses the video coding method and the video decoding method described in Embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 105 (b). In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350.

Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex356.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the video coding method shown in each of Embodiments, and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method.

Then, the modulation/demodulation unit ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a video decoding method corresponding to the coding method shown in each of Embodiments, and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the video coding method and the video decoding method in each of Embodiments can be used in any of the devices and systems described. Thus, the advantages described in each of Embodiments can be obtained.

Furthermore, the present invention is not limited to Embodiments, and various modifications and revisions are possible without departing from the scope of the present invention.

### Embodiment B

Video data can be generated by switching, as necessary, between (i) the video coding method or the video coding apparatus shown in each of Embodiments and (ii) a video coding method or a video coding apparatus in conformity with a different standard, such as MPEG-2, MPEG4-AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the video coding method and by the video coding apparatus shown in each of Embodiments will be hereinafter described. The multiplexed data is a digital stream in the MPEG2-Transport Stream format.

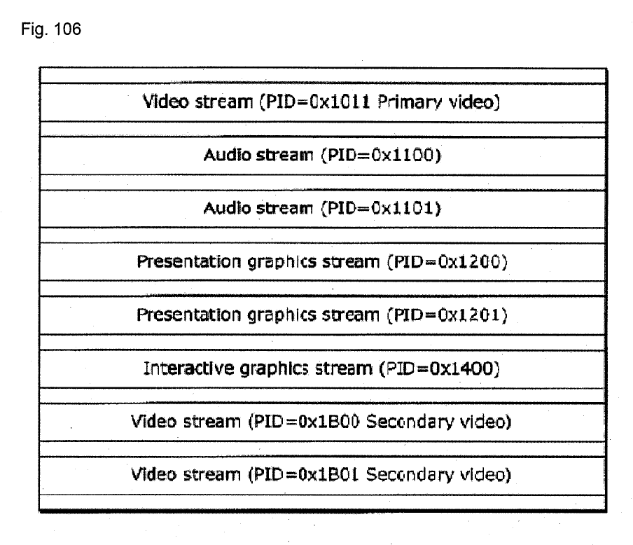

FIG. 106 illustrates a structure of the multiplexed data. As illustrated in FIG. 106, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the video coding method or by the video coding apparatus shown in each of Embodiments, or in a video coding method or by a video coding apparatus in conformity with a conventional standard, such as MPEG-2, MPEG4-AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0×1011 is allocated to the video stream to be used for video of a movie, 0×1100 to 0×111F are allocated to the audio streams, 0×1200 to 0×121F are allocated to the presentation graphics streams, 0×1400 to 0×141F are allocated to the interactive graphics streams, 0×1B00 to 0×1B1F are allocated to the video streams to be used for secondary video of the movie, and 0×A00 to 0×1A1F are allocated to the audio streams to be used for the secondary video to be mixed with the primary audio.

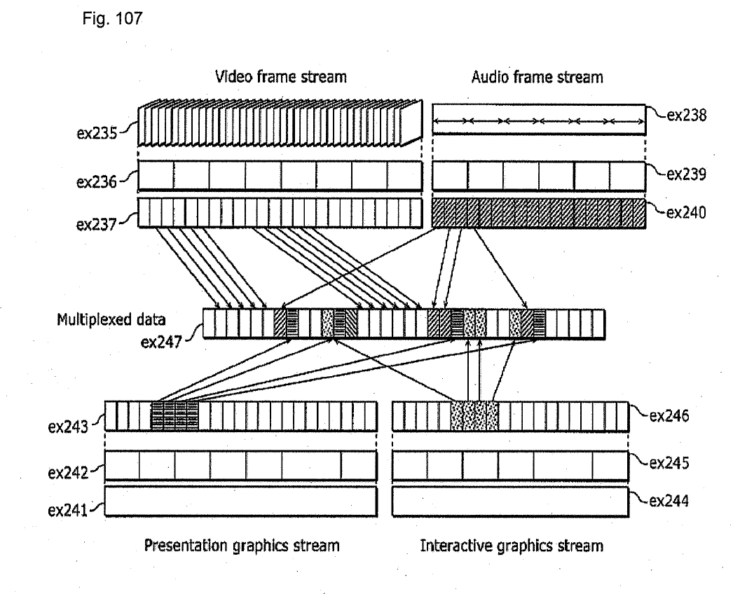

FIG. 107 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

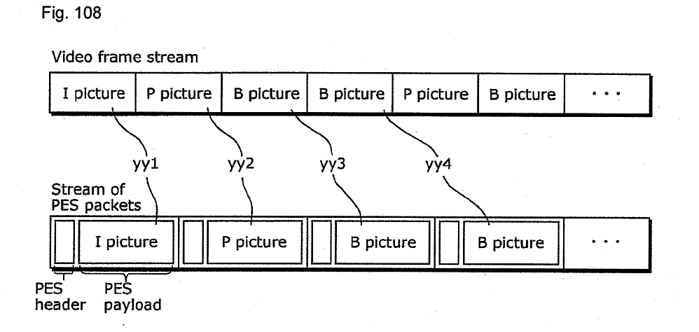

FIG. 108 illustrates how a video stream is stored in a stream of PES packets in more detail. The first bar in FIG. 108 shows a video frame stream in a video stream. The second bar shows the stream of PES packets. As indicated by arrows denoted as yy1, yy2, yy3, and yy4 in FIG. 108, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

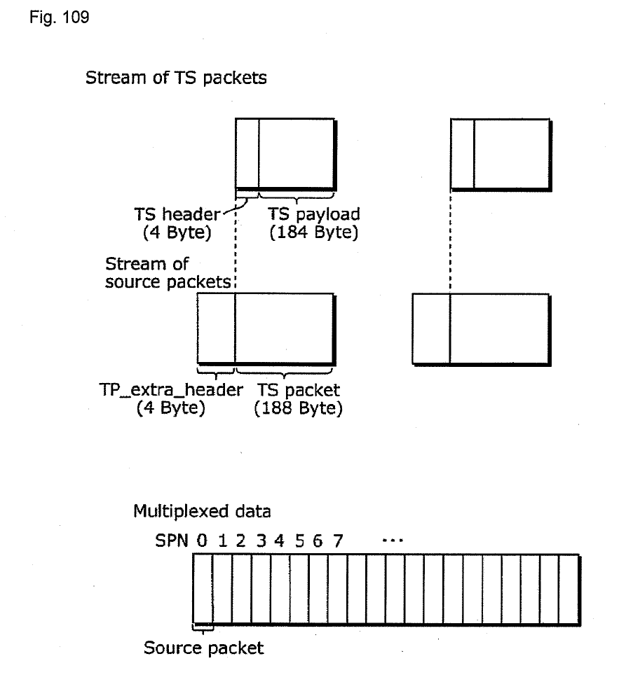

FIG. 109 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 109. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

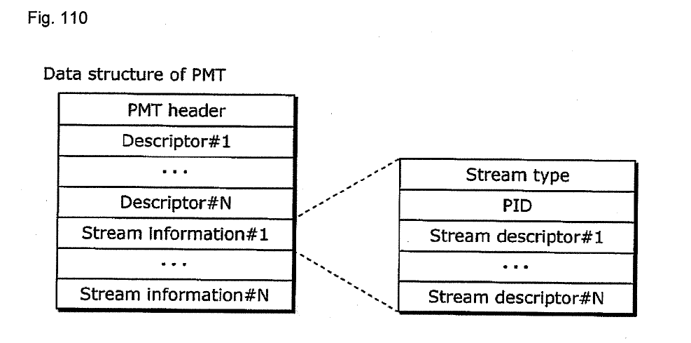

FIG. 110 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

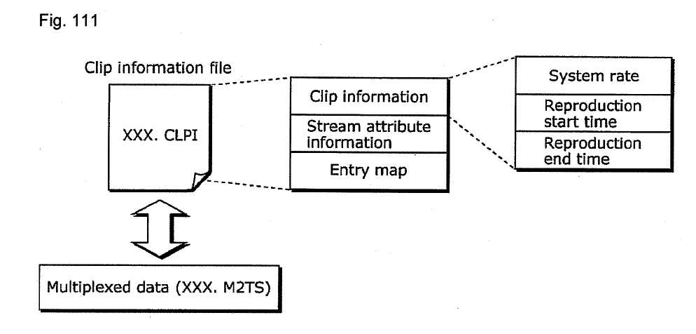

Each of the multiplexed data information files is management information of the multiplexed data as shown in FIG. 111. The multiplexed data information files are in one to one correspondence with the multiplexed data, and each of the files includes multiplexed data information, stream attribute information, and an entry map.

As illustrated in FIG. 111, the multiplexed data includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

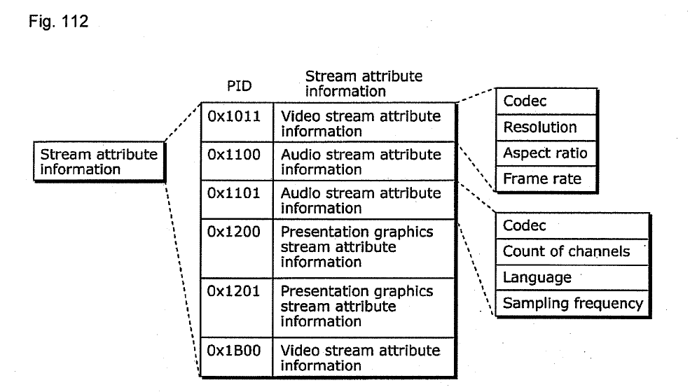

As shown in FIG. 112, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In Embodiment 9, the multiplexed data to be used is of a stream type included in the PMT. Furthermore, when the multiplexed data is recorded on a recording medium, the video stream attribute information included in the multiplexed data information is used. More specifically, the video coding method or the video coding apparatus described in each of Embodiments includes a step or a unit for allocating unique information indicating video data generated by the video coding method or the video coding apparatus in each of Embodiments, to the stream type included in the PMT or the video stream attribute information. With the configuration, the video data generated by the video coding method or the video coding apparatus described in each of Embodiments can be distinguished from video data that conforms to another standard.

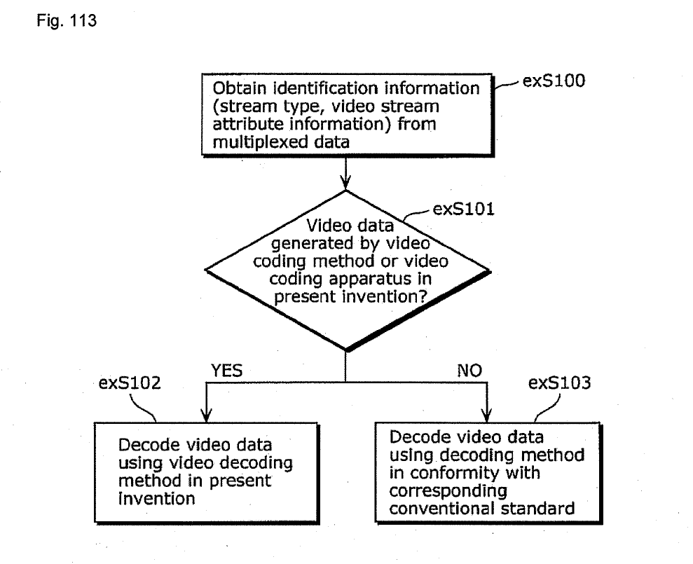

Furthermore, FIG. 113 illustrates steps of the video decoding method according to Embodiment 9. In Step exS100, the stream type included in the PMT or the video stream attribute information is obtained from the multiplexed data. Next, in Step exS101, it is determined whether or not the stream type or the video stream attribute information indicates that the multiplexed data is generated by the video coding method or the video coding apparatus in each of Embodiments. When it is determined that the stream type or the video stream attribute information indicates that the multiplexed data is generated by the video coding method or the video coding apparatus in each of Embodiments, in Step exS102, decoding is performed by the video decoding method in each of Embodiments. Furthermore, when the stream type or the video stream attribute information indicates conformance to the conventional standards, such as MPEG-2, MPEG4-AVC, and VC-1, in Step exS103, decoding is performed by a video decoding method in conformity with the conventional standards.

As such, allocating a new unique value to the stream type or the video stream attribute information enables determination whether or not the video decoding method or the video decoding apparatus that is described in each of Embodiments can perform decoding. Even when multiplexed data that conforms to a different standard, an appropriate decoding method or apparatus can be selected. Thus, it becomes possible to decode information without any error. Furthermore, the video coding method or apparatus, or the video decoding method or apparatus in Embodiment 9 can be used in the devices and systems described above.

### Embodiment C

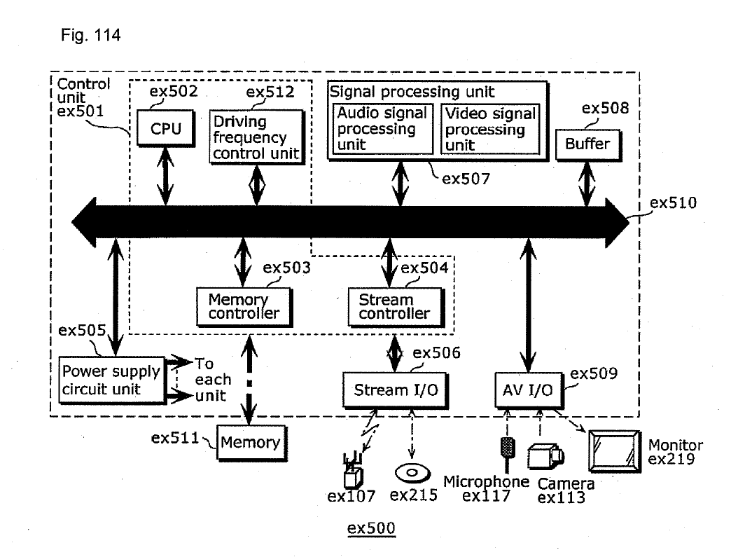

Each of the video coding method, the video coding apparatus, the video decoding method, and the video decoding apparatus in each of Embodiments is typically achieved in the form of an integrated circuit or a Large Scale Integrated (LSI) circuit. As an example of the LSI, FIG. 114 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of Embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording media ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex510 includes the CPU ex502, the memory controller ex503, the stream controller ex504, the driving frequency control unit ex512, the configuration of the control unit ex510 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

### Embodiment D

When video data generated in the video coding method or by the video coding apparatus described in each of Embodiments is decoded, compared to when video data that conforms to a conventional standard, such as MPEG-2, MPEG4-AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

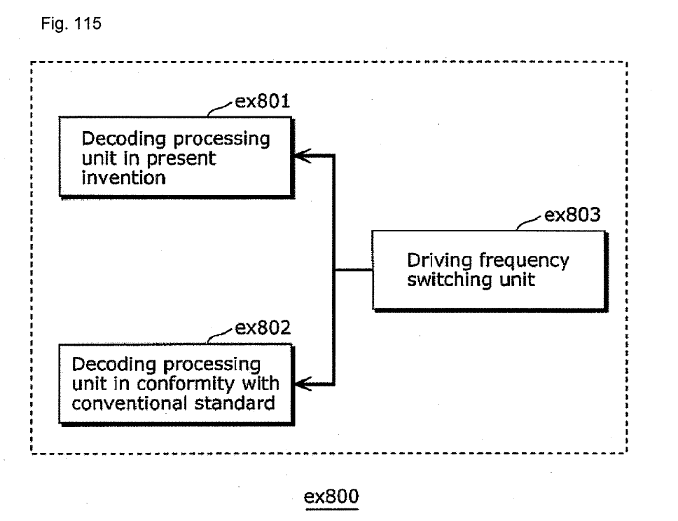

In order to solve the problem, the video decoding apparatus, such as the television ex300 and the LSI ex500 is configured to determine to which standard the video data conforms, and switch between the driving, frequencies according to the determined standard. FIG. 115 illustrates a configuration ex800 in Embodiment 11. A driving frequency switching unit ex803 sets a driving frequency to a higher driving frequency when video data is generated by the video coding method or the video coding apparatus described in each of Embodiments. Then, the driving frequency switching unit ex803 instructs a decoding processing unit ex801 that executes the video decoding method described in each of Embodiments to decode the video data. When the video data conforms to the conventional standard, the driving frequency switching unit ex803 sets a driving frequency to a lower driving frequency than that of the video data generated by the video coding method or the video coding apparatus described in each of Embodiments. Then, the driving frequency switching unit ex803 instructs the decoding processing unit ex802 that conforms to the conventional standard to decode the video data.

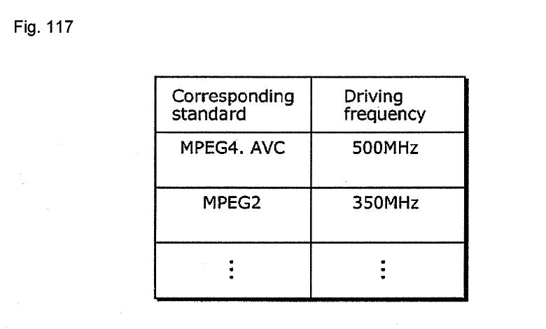

More specifically, the driving frequency switching unit ex803 includes the CPU ex502 and the driving frequency control unit ex512 in FIG. 114. Here, each of the decoding processing unit ex801 that executes the video decoding method described in each of Embodiments and the decoding processing unit ex802 that conforms to the conventional standard corresponds to the signal processing unit ex507 in FIG. 114. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 9 is probably used for identifying the video data. The identification information is not limited to the one described in Embodiment 9 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 117. The driving frequency can be selected by storing the look-up table in the buffer ex508 and in an internal memory of an LSI, and with reference to the look-up table by the CPU ex502.

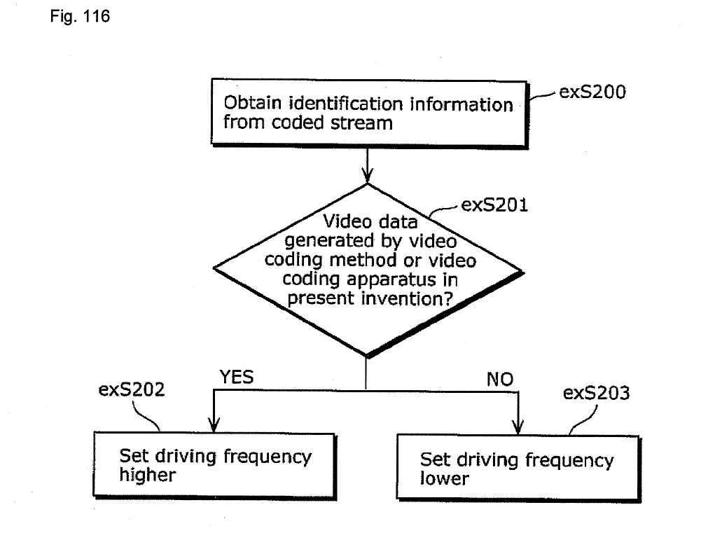

FIG. 116 illustrates steps for executing a method in Embodiment 11. First, in Step exS200, the signal processing unit ex507 obtains identification information from the multiplexed data. Next, in Step exS201, the CPU ex502 determines whether or not the video data is generated by the coding method and the coding apparatus described in each of Embodiments, based on the identification information. When the video data is generated by the video coding method and the video coding apparatus described in each of Embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG4-AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the video coding method and the video coding apparatus described in each of Embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG4-AVC is larger than the processing amount for decoding video data generated by the video coding method and the video coding apparatus described in each of Embodiments, the driving frequency is probably set in reverse order to the setting described above.

Furthermore, the method for setting the driving frequency is not limited to the method for setting the driving frequency lower. For example, when the identification information indicates that the video data is generated by the video coding method and the video coding apparatus described in each of Embodiments, the voltage to be applied to the LSI ex500 or the apparatus including the LSI ex500 is probably set higher. When the identification information indicates that the video data conforms to the conventional standard, such as MPEG-2, MPEG4-AVC, and VC-1, the voltage to be applied to the LSI ex500 or the apparatus including the LSI ex500 is probably set lower. As another example, when the identification information indicates that the video data is generated by the video coding method and the video coding apparatus described in each of Embodiments, the driving of the CPU ex502 does not probably have to be suspended. When the identification information indicates that the video data conforms to the conventional standard, such as MPEG-2, MPEG4-AVC, and VC-1, the driving of the CPU ex502 is probably suspended at a given time because the CPU ex502 has extra processing capacity. Even when the identification information indicates that the video data is generated by the video coding method and the video coding apparatus described in each of Embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG4-AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment E

There are cases where a plurality of video data that conforms to different standards, is provided to the devices and systems, such as a television and a mobile phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

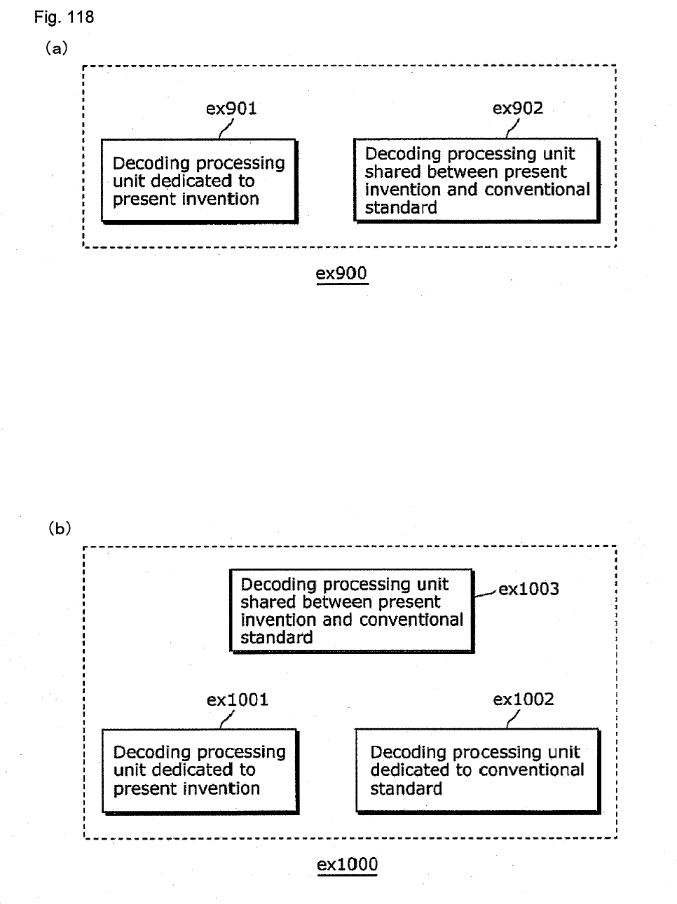

In order to solve the problem, what is conceived is a configuration in which the decoding processing unit for implementing the video decoding method described in each of Embodiments and the decoding processing unit that conforms to the conventional standard, such as MPEG-2, MPEG4-AVC, and VC-1 are partly shared. Ex900 in FIG. 118(a) shows an example of the configuration. For example, the video decoding method described in each of Embodiments and the video decoding method that conforms to MPEG4-AVC have, partly in common, the details of processing, such as entropy coding, inverse quantization, deblocking filtering, and motion compensated prediction. The details of processing to be shared probably includes use of a decoding processing unit ex902 that conforms to MPEG4-AVC. In contrast, a dedicated decoding processing unit ex901 is probably used for other processing unique to the present invention. Since the present invention is characterized by a transformation unit in particular, for example, the dedicated decoding processing unit ex901 is used for inverse transform. Otherwise, the decoding processing unit is probably shared for one of the entropy coding, inverse quantization, deblocking filtering, and motion compensated prediction, or all of the processing. The decoding processing unit for implementing the video decoding method described in each of Embodiments may be shared for the processing to be shared, and a dedicated decoding processing unit may be used for processing unique to that of MPEG4-AVC.

Furthermore, ex1000 in FIG. 118(b) shows another example in that processing is partly shared. This example uses a configuration including a dedicated decoding processing unit ex1001 that supports the processing unique to the present invention, a dedicated decoding processing unit ex1002 that supports the processing unique to another conventional standard, and a decoding processing unit ex1003 that supports processing to be shared between the video decoding method in the present invention and the conventional video decoding method. Here, the dedicated decoding processing units ex1001 and ex1002 are not necessarily specialized for the processing of the present invention and the processing of the conventional standard, respectively, and may be the ones capable of implementing general processing. Furthermore, the configuration of Embodiment 12 can be implemented by the LSI ex500.

As such, reducing the scale of the circuit of an LSI and reducing the cost are possible by sharing the decoding processing unit for the processing to be shared between the video decoding method in the present invention and the video decoding method in conformity with the conventional standard.

What is claimed is:

1. A method of encoding images of a plurality of views using multiview video coding standard and MPEG-2 video standard comprising of:
encoding an image of a first view using MPEG-2 video coding tools;
writing said coded image in a byte stream format conforming to MPEG-2 video specification;
determining NAL unit header mvc extension parameters for an image of a second view;
computing NAL unit header mvc extension parameters for said MPEG-2 coded image of said first view;
encoding said image of said second view using said NAL unit header mvc extension parameters of both said first and second views and MPEG-4 MVC coding tools; and
writing said coded image of second view in NAL units conforming to MPEG-4 MVC specification.

2. A method of decoding images of a plurality of views using multiview video coding standard and MPEG-2 video standard comprising of:
parsing a coded image of a first view based on MPEG-2 video specification;
decoding said image of said first view using MPEG-2 video decoding tools;
parsing NAL unit header mvc extension parameters for a coded image of a second view based on MPEG-4 MVC specification;
computing NAL unit header mvc extension parameters for said coded image of said first view;
parsing said coded image of said second view based on MPEG-4 MVC specification; and
decoding said coded image of said second view using NAL unit header mvc extension parameters of both said first and second views and MPEG-4 MVC decoding tools.

3. Methods of encoding and decoding images of a plurality of views using multiview video coding standard and MPEG-2 video standard according to claim 1, whereas computing NAL unit header mvc extension parameters for said MPEG-2 coded image of said first view comprising of:
assigning values for a plurality of parameters from NAL unit header mvc extension parameters for said coded image of said second view to parameters of said image of first view;
assigning a priority identification value for said image of first view with a first pre-defined value;
assigning a view identification value for said image of first view with a second pre-defined value;
parsing a picture coding type parameter from a picture header of said image of first view;
judging if said picture coding type parameter contains a third pre-defined value;
wherein, if said picture coding type parameter contains a third pre-defined value, setting an inter-view flag parameter for said image of first view to a zero value;
wherein, if said picture coding type parameter does not contain a third pre-defined value, setting said inter-view flag parameter for said image of first view to an one value.

4. A method of decoding images of a plurality of views using multiview video coding standard and MPEG-2 video standard comprising of:
parsing a presentation time from a header of an image of a base view;
deriving a decoding time for said coded image of base view;
decoding said coded image at said decoding time;
computing a new presentation time for said coded image of base view by delaying said parsed presentation time by an offset value; and
presenting said decoded image at said newly computed presentation time.

5. A method of decoding images of a plurality of views using multiview video coding standard and MPEG-2 video standard comprising of:
parsing a presentation time from a header of an image of a non base view;
parsing a decoding time from said header of said coded image of non base view;
computing a new decoding time for said coded image of non base view by delaying said parsed decoding time by an offset value;
decoding said coded image at said computed decoding time;
computing a new presentation time for said coded image of non base view by delaying said parsed presentation time by said offset value; and
presenting said decoded image at said newly computed presentation time.

6. A method of decoding audio samples associated to a plurality of views coded using multiview video coding standard and MPEG-2 video standard comprising of:
parsing a presentation time from a header of coded audio samples;
deriving a decoding time from said header;
computing a new decoding time for said coded audio samples by delaying said parsed decoding time by an offset value;
decoding said audio samples at said computed decoding time;
computing a new presentation time for said decoded audio samples by delaying said parsed presentation time by said offset value; and
presenting said decoded audio samples at said newly computed presentation time.

7. An apparatus for encoding images of a plurality of views using multiview video coding standard and MPEG-2 video standard, the apparatus comprising:
an encoding unit configured to encode an image of a first view using MPEG-2 video coding tools;
a writing unit configured to write said coded image in a byte stream format conforming to MPEG-2 video specification;
a derivation unit configured to determine NAL unit header mvc extension parameters for an image of a second view;
a computing unit configured to compute NAL unit header mvc extension parameters for said MPEG-2 coded image of said first view;
an encoding unit configured to encode said image of said second view using said NAL unit header mvc extension parameters of both said first and second views and MPEG-4 MVC coding tools; and
a writing unit configured to write said coded image of second view in NAL units conforming to MPEG-4 MVC specification.

8. An apparatus for decoding images of a plurality of views using multiview video coding standard and MPEG-2 video standard comprising of:
a parsing unit configured to parse a coded image of a first view based on MPEG-2 video specification;
a decoding unit configured to decode said image of said first view using MPEG-2 video decoding tools;
a parsing unit configured to parse NAL unit header mvc extension parameters for a coded image of a second view based on MPEG-4 MVC specification;
a computing unit configured to compute NAL unit header mvc extension parameters for said coded image of said first view;
a parsing unit configured to parse said coded image of said second view based on MPEG-4 MVC specification; and
a decoding unit configured to decode said coded image of said second view using NAL unit header mvc extension parameters of both said first and second views and MPEG-4 MVC decoding tools.

9. Apparatuses for encoding and decoding images of a plurality of views using multiview video coding standard and MPEG-2 video standard according to claim 7, whereas said computing unit configured to compute NAL unit header mvc extension parameters for said MPEG-2 coded image of said first view comprising of:
an assignment unit configured to assign values for a plurality of parameters from NAL unit header mvc extension parameters for said coded image of said second view to parameters of said image of first view;
an assignment unit configured to assign a priority identification value for said image of first view with a first pre-defined value;
an assignment unit configured to assign a view identification value for said image of first view with a second pre-defined value;
a parsing unit configured to parse a picture coding type parameter from a picture header of said image of first view;
a judging unit configured to judge if said picture coding type parameter contains a third pre-defined value;
wherein, if said picture coding type parameter contains a third pre-defined value;
an assignment unit configured to set an inter-view flag parameter for said image of first view to a zero value;
wherein, if said picture coding type parameter does not contain a third pre-defined value;
an assignment unit configured to set said inter-view flag parameter for said image of first view to an one value.

10. An apparatus for decoding images of a plurality of views using multiview video coding standard and MPEG-2 video standard comprising of:
a parsing unit configured to parse a presentation time from a header of an image of a base view;
a deriving unit configured to derive a decoding time for said coded image of base view;
a decoding unit configured to decode said coded image at said decoding time;
a computing unit configured to compute a new presentation time for said coded image of base view by delaying said parsed presentation time by an offset value; and
a presentation unit configured to present said decoded image at said newly computed presentation time.

11. An apparatus for decoding images of a plurality of views using multiview video coding standard and MPEG-2 video standard comprising of:
a parsing unit configured to parse a presentation time from a header of an image of a non base view;
a parsing unit configured to parse a decoding time from said header of said coded image of non base view;
a computing unit configured to compute a new decoding time for said coded image of non base view by delaying said parsed decoding time by an offset value;
a decoding unit configured to decode said coded image at said computed decoding time;
a computing unit configured to compute a new presentation time for said coded image of non base view by delaying said parsed presentation time by said offset value; and
a presentation unit configured to present said decoded image at said newly computed presentation time.

12. An apparatus for decoding audio samples associated to a plurality of views coded using multiview video coding standard and MPEG-2 video standard comprising of:
a parsing unit configured to a presentation time from a header of coded audio samples;
a deriving unit configured to derive a decoding time from said header;
a computing unit configured to compute a new decoding time for said coded audio samples by delaying said parsed decoding time by an offset value;
a decoding unit configured to decode said audio samples at said computed decoding time;
a computing unit configured to compute a new presentation time for said decoded audio samples by delaying said parsed presentation time by said offset value; and
a presentation unit configured to present said decoded audio samples at said newly computed presentation time.

13. Methods of encoding and decoding images of a plurality of views using multiview video coding standard and MPEG-2 video standard according to claim 2, whereas computing NAL unit header mvc extension parameters for said MPEG-2 coded image of said first view comprising of:
assigning values for a plurality of parameters from NAL unit header mvc extension parameters for said coded image of said second view to parameters of said image of first view;
assigning a priority identification value for said image of first view with a first pre-defined value;
assigning a view identification value for said image of first view with a second pre-defined value;
parsing a picture coding type, parameter from a picture header of said image of first view;
judging if said picture coding type parameter contains a third pre-defined value;
wherein, if said picture coding type parameter contains a third pre-defined value, setting an inter-view flag parameter for said image of first view to a zero value;
wherein, if said picture coding type parameter does not contain a third pre-defined value, setting said inter-view flag parameter for said image of first view to an one value.

14. Apparatuses for encoding and decoding images of a plurality of views using multiview video coding standard and MPEG-2 video standard according to claim 8, whereas said computing unit configured to compute NAL unit header mvc extension parameters for said MPEG-2 coded image of said first view comprising of:
an assignment unit configured to assign values for a plurality of parameters from NAL unit header mvc extension parameters for said coded image of said second view to parameters of said image of first view;
an assignment unit configured to assign a priority identification value for said image of first view with a first pre-defined value;
an assignment unit configured to assign a view identification value for said image of first view with a second pre-defined value;
a parsing unit configured to parse a picture coding type parameter from a picture header of said image of first view;
a judging unit configured to judge if said picture coding type parameter contains a third pre-defined value;
wherein, if said picture coding type parameter contains a third pre-defined value;
an assignment unit configured to set an inter-view flag parameter for said image of first view to a zero value;
wherein, if said picture coding type parameter does not contain a third pre-defined value;
an assignment unit configured to set said inter-view flag parameter for said image of first view to an one value.
